(19) United States
(12) Patent Application Publication
(10) Pub. No.: US 2004/0073437 A1
(43) Pub. Date: Apr. 15, 2004

(54) Methods and systems for providing enhanced access to televised sporting events

(76) Inventors: Joseph F. Halgas JR., Huntingdon Valley, PA (US); John Kamieniecki, Lafayette Hill, PA (US); Christopher J. Stone, Newtown, PA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/271,308

(22) Filed: Oct. 15, 2002

(51) Int. Cl. G06F 17/60

(52) U.S. Cl. 705/1

(57) ABSTRACT

A method and system provide updates of sporting events, including video highlights, to a television or handheld internet-based pad. This method preferably includes recording one or more sporting events, tagging specific plays as highlights of the one or more sporting events, storing the tagged highlights on a server, combining the tagged highlights with a video stream of a provider, accessing the tagged highlights at a consumer location, notifying a user that a highlight has occurred, and displaying the highlights on a television or handheld internet-based pad.

### TECHNICAL FIELD

The present invention relates to the field of television services. More specifically, the present invention relates to the fields of subscription sports television, interactive television and web-based devices supporting interactive television.

### BACKGROUND OF THE INVENTION

Products and services that are designed to enhance the television viewing experience have become more common in recent years. PVR's (Personal Video Recorders), subscription-only packages, dish satellites, Pay-per-View, and other television service enhancements, provide users with a wide variety of television-based entertainment options.

Recently, handheld devices, known as web-pads, have been made available to the public. Web-pads are capable of displaying internet-based content related to television programming and television-based services. Web-pads enable a user to browse the internet or access web-content related to television programs and services by connecting wirelessly to the Internet through a cable modem. The cable modem may be incorporated in, connected to, or used with a set-top box that makes the services of a proprietary television system, such as a cable or satellite television system, available to a subscriber.

One type of television program particularly suitable for viewer interaction using a web-pad is sporting events. Using the web-pad, a user may access content on the internet, e.g., scores, team and player statistical information, schedules, interviews, etc., while watching a game or sporting event on television. Additionally, some web-sites now offer high-resolution video clips of “important” plays, e.g., touchdowns, turnovers, homeruns, slam dunks, etc., in order to allow interested sports fans to view or re-view the important plays when convenient.

Many sports fan enjoy watching replays and reviewing statistical information about players and teams. Numerous “fantasy” sports clubs have been created that allow members to participate in a “fantasy” season in which points are accrued for team and individual player performance based on actual sporting events.

While many game highlights and individual performances may be seen on the internet or during sports highlight programs, these presentations are limited. Sports update programs only show a limited number of highlights from selected games and may only be seen at scheduled times. Sports information on the internet is plentiful, but video replays of game highlights may be limited and may require the user to go to his or her computer to access the Internet to view the available clips.

Some sports fans choose to pay for special subscription sports packages. Such packages provide expanded coverage of all the events in a particular sport, league or conference, or the sporting events or games of a particular team or institution, such as a university, etc. By purchasing such a sports package, the purchaser receives television access to a larger number of “live” or re-televised games or events that are the subject of the special package. While subscription sports packages provide many opportunities to see additional games or events, it is still difficult for some fans to monitor all games of interest for highlights, scores, stats, etc.

### SUMMARY OF THE INVENTION

The present invention provides, among other things, a method and system for providing “real-time” updates of sports highlights, including, scores, player reports, video of “big plays,” etc., to a television or handheld “web-pad.”

Another aspect of the present invention encompasses a video tagging method. By placing tags or “bookmarks” in a video stream, a set-top box or digital receiver can recognize and jump to a specific tagged location in the video stream. The tagged locations correspond, for example, to important moments or plays in a sporting event.

A further embodiment within the teachings of the present invention encompasses a recording device, connected to a set-top box for recording tagged portions of a video streams containing sports highlights, etc.

### BRIEF DESCRIPTION OF THE DRAWINGS

The accompanying drawings illustrate various embodiments of the present invention and are a part of the specification. Together with the following description, the drawings demonstrate and explain the principles of the present invention. The illustrated embodiments are examples of the present invention and do not limit the scope of the invention.

FIG. 1 illustrates a system for enhancing the broadcast of sporting events and news according to an embodiment of the present invention.

FIG. 2 illustrates another embodiment of a system according to the present invention.

FIG. 3 is a block diagram illustrating a method of tagging plays of a sporting event according to an embodiment of the present invention.

FIG. 4 is a flowchart illustrating a method of accessing individual plays from sporting events according to an embodiment of the present invention.

FIG. 5 is a flowchart illustrating a preferred method of providing game highlights to users according to an embodiment of the present invention.

Throughout the drawings, identical reference numbers designate similar, but not necessarily identical, elements.

### DETAILED DESCRIPTION OF EMBODIMENTS OF THE INVENTION

The present invention provides a method and system for tagging plays of one or more video broadcast sporting events and conveying real-time updates of sports highlights to a user's television or handheld device. The tags are “bookmarks” which are inserted into the video stream during a game, i.e., the tags denote the beginning of each play or a passage of time. Once a play has been recorded, additional information can be added, e.g., score, player names, stats, etc. If the play is considered “important,” it is saved on a server permanently and an update of “important” plays that are available can be sent to the users of the service. The user then has a variety of options, e.g., view the play, watch the sporting event corresponding to the important play, store the play, etc.

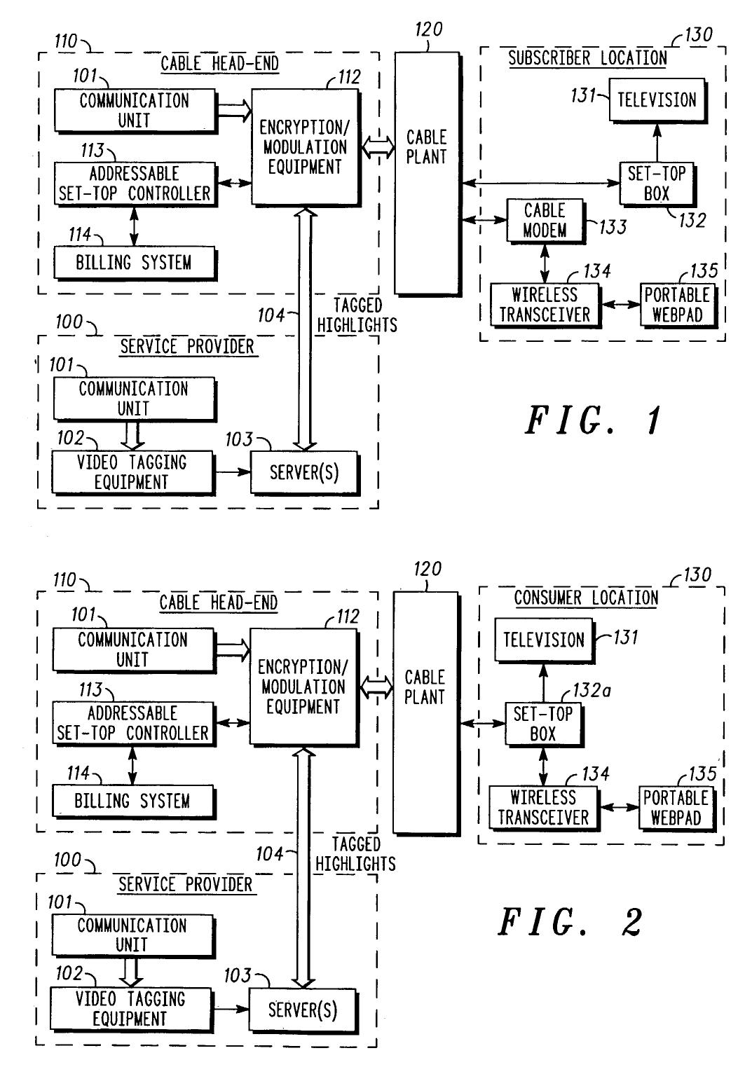

FIG. 1 illustrates a system for enhancing the broadcast of sporting events and news according to an embodiment of the present invention. As shown in FIG. 1, the invention involves a service provider (100), a cable head-end (110), i.e., a cable television company's local facility that originates and communicates cable modem and cable television services to its subscribers, a cable plant (120), and equipment at the consumer location (130).

The service provider (100) may be a content provider, e.g., a sports network or a general network providing sports programming. Alternatively, the service provider (100) maybe a cable television company. In either case, the service provider (100) preferably performs the tagging of plays during the broadcast of a sporting event. In order to tag the plays of a sporting event, a communication unit (101), e.g., a satellite dish, receives the video stream and sends the video stream to video tagging equipment (102). The video tagging equipment (102) may comprise video editing equipment and software. When a play meets certain criteria, i.e., when a play is considered a highlight, it is stored on a server (103). A human editor may be employed to determine and indicate which plays or moments of a sporting even qualify for storage on the server (103). Alternatively, other automated criteria may be employed, such as volume of spectator response to the play or action.

At the cable head-end (110), a communication unit (101) receives all the channels that the particular cable provider offers to its subscribers. This video/audio stream is sent to encryption/modulation equipment (112), where the data stream is prepared for transmission to the subscribers. Using a billing system (114) and an addressable set-top controller (113), only the data stream corresponding to each customer's subscription is made available to a particular customer location (130). For example, some customers may subscribe only to a basic service, while others may subscribe to the basic service plus a premium sports package.

As an additional service, the cable company may include the tagged highlights (104) and other information stored on one or more servers (103) of the service provider (100) to the data stream sent to the subscriber. The addition of the tagged highlights (104) to the data stream is accomplished by modulation, i.e., a data stream containing tagged highlights (104), etc., is added to the data stream sent to the customer using the modulation equipment (112).

After the data stream has been prepared, it is sent through a cable plant (120), i.e., a network of cable lines, to the location of the subscriber (130). In FIG. 1, the data stream is accessed by a set-top box (132) and, perhaps, a cable modem (133). In some embodiment, the set-top box (132) and cable modem (133) are integrated into a single unit. The set-top box (132) processes the encrypted data stream and allows the consumer to view the video and audio contained in the data stream from the head-end (110). Additionally, the set-top box (132) preferably has the ability to recognize tags and “jump” to a tag in the video stream. The cable modem (133) is connected to a wireless transceiver, preferably a radio frequency (RF) or infrared (IR) transceiver (134), which enables a web-pad (135) to wirelessly connect to a high-speed internet connection offered through the cable plant (120).

The web-pad (135) is a versatile device and may be used for a variety of purposes, such as, controlling the television (131) or other electronic devices, view internet content, notify a user of new sports highlights, view sports highlights, etc. In a preferred embodiment, the web-pad (135) will keep track of all sporting events occurring, notify the user when a “big play” has occurred, and provide instant access to a replay that can be viewed on the television (131) or the web-pad (135).

FIG. 2 illustrates another embodiment of a system according to the present invention. In FIG. 2, the cable modem of FIG. 1 is incorporated into the set-top box (132a). Consequently, the set-top box (132a) provides, in a single unit, the capability to receiving and decoding the television signal provided from the head-end (110), as well as providing high-speed Internet access through the cable plant (120).

Additionally or alternatively, the set-top box (132a) may include a Personal Video Recorder (PVR) to record television programs, etc. A PVR is a device that includes a high-volume digital data storage device, such as one or more hard drives, on which incoming television programming can be recorded. The PVR may also comprise a buffer for the incoming television programming so that the user can, in effect, pause the live broadcast of the programming for a period of time corresponding to the size of the buffer in the PVR. Any or all of this PVR functionality may be incorporated into the set-top box (132a).

FIG. 3 is a block diagram illustrating a method of tagging video and audio data streams (301). The recorded video and audio streams (301) are represented by a summation of video/audio time intervals (302) starting at time X. When an important event occurs (304), a tag (303) is inserted into the data stream (301) to “bookmark” the event. A tag (303) may also be placed at the end of the important event (304). An alternative method would be to tag (303) a video stream (301) at certain time intervals (302), e.g., every 10 seconds, and then choose which tags (303) define an important event (304). In the example of FIG. 3, the important event (304) could be precisely tagged manually after the event has occurred at t=X+2.3 and t=X+4.5. If an automatic tagging system is used, tags could be inserted at t=X+1, t=X+2, t=X+3, t=X+4, t=X+5, etc. By using the tag at t=X+2 as the beginning tag and the tag at t=X+5 as the ending tag, the important play can be saved and replayed in its entirety.

In a preferred embodiment, tags are inserted in the MPEG (Moving Picture Experts Group) stream as a descriptor. The tags may also be inserted into lines 10-20 of the VBI (Vertical Blanking Interval). The vertical blanking interval is a portion of a television signal that can carry information other than video or audio data, such as closed-caption text, etc.

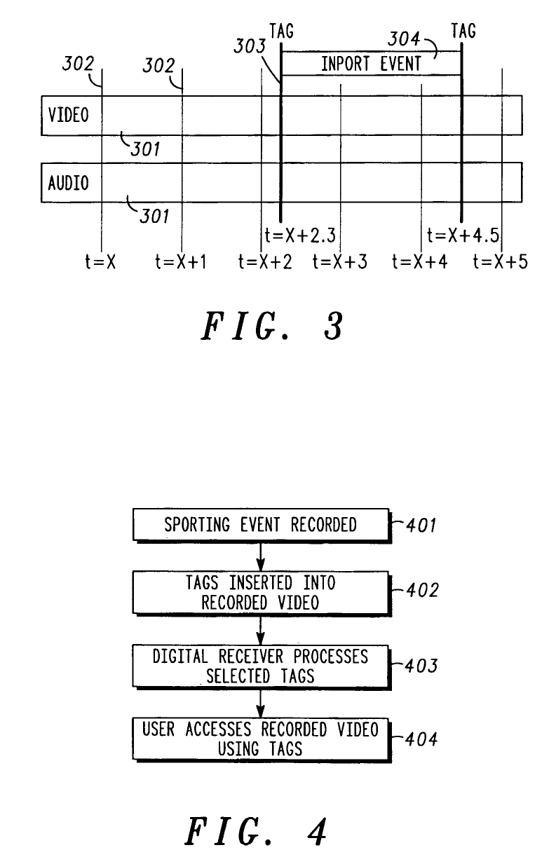

FIG. 4 is a flowchart illustrating a method of providing real-time replays of sports highlights to consumer televisions or web-pads. As shown in FIG. 4, a sporting event is first recorded (step 401). As the sporting event is being recorded, the data stream is sent to a location where tags are inserted (step 402) into the data stream either manually or automatically. Using a digital receiver (e.g., a set-top box) to process the tags (step 403) and an interactive handheld device, a consumer may choose to jump to any tag in the data stream and view the content (step 404).

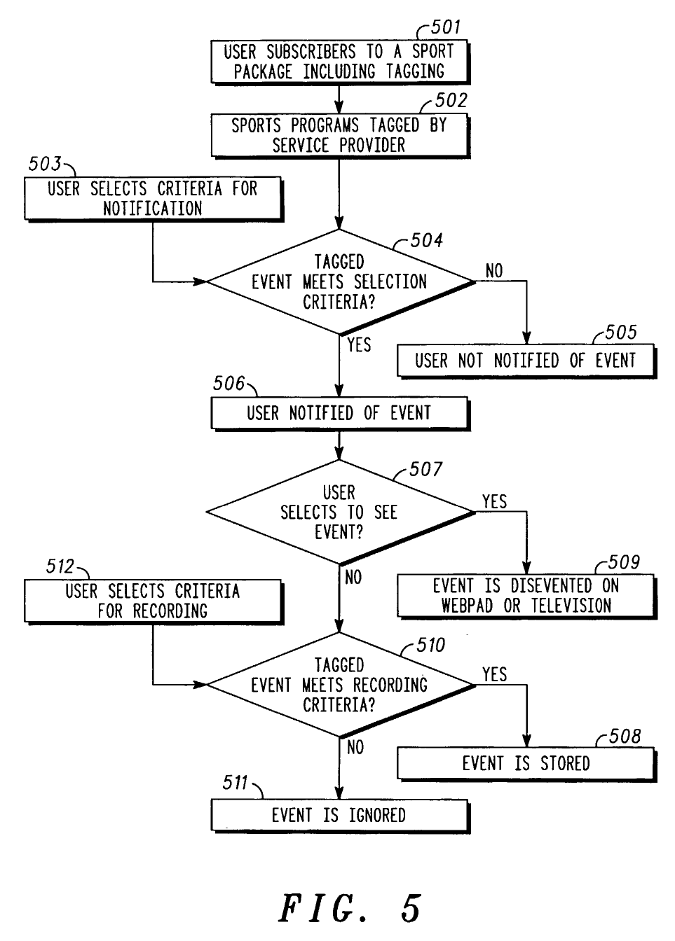

FIG. 5 is a flowchart illustrating a preferred method of providing sports highlights to users according to an embodiment of the present invention. In the preferred embodiment, the user subscribes to a premium sports service that includes a “real-time” replay service (step 501). The real-time replay service may be optional and could cost the consumer an additional charge. In order to provide the real-time replays, the service provider places tags in the data stream indicating the location of sports highlights (step 502).

Preferably, the service is provided using a set-top box and web-pad. However, it will be understood that the functions of the web-pad could be replaced by displaying information on the subscriber's television and having the user enter responses using a remote control unit that is not a web-pad.

Using the web-pad or other input device, the user may pre-select criteria upon which notification will be made to the user that a “big play” or highlight has occurred and is stored for play or replay (step 503). For example, the user may only be interested in touchdowns occurring in National Football League (NFL) football games. The system allows the user to specify the type of plays he or she is interested. The plays or events can be specified by sport, event type, team, player, etc. These criteria are preferably transmitted to and stored in the user's set[top box.

The set-top box will compare the user's specified criteria to tags in the incoming audiovisual data stream. If a tagged event meets the criteria input by the user (determination 504), the web-pad or the subscriber's television displays a description of the tagged event and prompts the user to choose whether to play or replay the tagged event (step 506). If a tagged event does not meet the criteria input by the user (determination 504), no notification is sent to the user (step 505).

If a notification is sent (step 506), the user may select to watch the tagged event (determination 507) on the television or the web-pad. If the user wishes to watch the play on the television, the set-top box can be force-tuned to a virtual channel where the streaming video of the tagged event will be broadcast. Once the play has finished, the set-top box can retune to the last channel that the user had been viewing at the time.

If the user wishes to view the play on the web-pad, the server can stream the play in a standardized streaming format compatible with the web-pad. In this mode, the primary viewing experience on the television is uninterrupted. Consequently, whether the user is watching the sporting event in which the tagged event occurs or is watching something else, events of interest in all available broadcast sporting events can be brought to the user's attention and are available for viewing by the user at the user's convenience.

The user may also select not to view the tagged event when the notification is sent (determination 507). In this case, the tagged event may be ignored or the tagged event may be stored (step 508) to view at a later time.

In order to store tagged video stream, the set-top box is preferably connected to, or incorporates, a VCR or PVR. Using the web-pad or other remote control device, a user may select or pre-select what types of tagged event to record or save (step 512) in the same manner that the user specified which type of events should generate notifications. The set-top box browses through the tags (determination 510) and records events that meet the user's criteria or sends the video stream of the events that meet the user's criteria to a VCR or PVR (step 508). In this way, tagged events can be made available to the user, even if the user is not watching television at all at the time when the tagged event occurs or is broadcast. Events that do not meet the criteria may be ignored (step 511).

The web-pad or other remote control unit preferably includes a RF or IR transceiver for communicating with the set-top box and/or a VCR or PVR. A PVR or VCR would be incorporated to allow the user to “jump back” to a particular play. When the jump-back process is initiated, the device will rewind to the designated tag and initiate a play sequence. It is also possible for the cable providers to place archived “tagged” clips on a central server located in the head-end. Users who do not have access to a PVR or VCR-equipped device can access the instant replay and rewind service using a Video-on-Demand (VOD) type of delivery system.

The preceding description has been presented only to illustrate and describe embodiments of invention. It is not intended to be exhaustive or to limit the invention to any precise form disclosed. Many modifications and variations are possible in light of the above teaching.

The foregoing embodiments were chosen and described in order to illustrate principles of the invention and some practical applications. The preceding description enables others skilled in the art to utilize the invention in various embodiments and with various modifications as are suited to the particular use contemplated. It is intended that the scope of the invention be defined by the following claims.

What is claimed is:

1. A method of providing enhanced user access to televised sporting events, said method comprising:
producing an audiovisual data stream of a sporting event for transmission to subscribers; and
inserting tags in said data stream to create tagged portions of said data stream;
wherein said tagged portions of said data stream correspond to important events in said sporting event.

2. The method of claim 1, further comprising transmitting said data stream including said tagged portions.

3. The method of claim 2, further comprising:
receiving said data stream; and
alerting a user to said tagged portions of said data stream.

4. The method of claim 3, wherein said alerting a user comprises wireless transmitting information about tagged portions of said data stream to a user's remote control unit.

5. The method of claim 3, wherein said alerting a user comprises displaying information about said tagged portions of said data stream on a television set.

6. The method of claim 3, further comprising:
receiving user input regarding user interest in a tagged portion of said data stream; and
based on said user input, playing or ignoring said tagged portion of said data stream.

7. The method of claim 6, wherein playing said tagged portion of said data stream further comprises:
transmitting said tagged portion to a remote control unit having a display device; and
playing said tagged portion of said data stream on said remote control unit.

8. The method of claim 6, wherein playing said tagged portion of said data stream further comprises:
tuning to a virtual channel with a set-top box over which said tagged portion of said data stream is broadcast; and
playing said tagged portion of said data stream on a television set connected to said set-top box.

9. The method of claim 1, further comprising:
in said tags, inserting a description of the important event marked by said tags; and
transmitting said data stream, including said tagged portions.

10. The method of claim 9, further comprising:
comparing said description with predetermined criteria; and
alerting a user to said tagged portions of said data stream if said description matches said predetermined criteria.

11. The method of claim 9, further comprising:
comparing said description with predetermined criteria; and
recording one or more tagged portions of said data stream if said description matches said predetermined criteria.

12. A method of providing enhanced user access to televised sporting events, said method comprising:
receiving an audiovisual data stream of a sporting event, said data stream containing tagged portion;
wherein said tagged portions of said data stream correspond to important events in said sporting event.

13. The method of claim 12, alerting a user to said tagged portions of said data stream.

14. The method of claim 13, wherein said alerting a user comprises wireless transmitting information about tagged portions of said data stream to a user's remote control unit.

15. The method of claim 13, wherein said alerting a user comprises displaying information about said tagged portions of said data stream on a television set.

16. The method of claim 13, further comprising:
receiving user input regarding user interest in a tagged portion of said data stream; and
based on said user input, playing or ignoring said tagged portion of said data stream.

17. The method of claim 16, wherein playing said tagged portion of said data stream further comprises:
transmitting said tagged portion to a remote control unit having a display device; and
playing said tagged portion of said data stream on said remote control unit.

18. The method of claim 16, wherein playing said tagged portion of said data stream further comprises:
tuning to a virtual channel with a set-top box over which said tagged portion of said data stream is broadcast; and
playing said tagged portion of said data stream on a television set connected to said set-top box.

19. The method of claim 12, further comprising:
comparing predetermined criteria with a description of the important event included with said tags identifying said important event; and
alerting a user to said tagged portion of said data stream if said description matches said predetermined criteria.

20. The method of claim 12, further comprising:
comparing predetermined criteria with a description of the important event included with said tags identifying said important event; and
recording one or more tagged portions of said data stream if said description matches said predetermined criteria.

21. A system for providing televised sporting events with enhanced user access to highlights from the sporting events, said system comprising:
tagging equipment for inserting tags into an audiovisual data stream of a sporting event, said tags identifying important events within the sporting event; and
a broadcast head-end for transmitting said data stream including said tags.

22. The system of claim 21, further comprising a server for storing tagged portions of said audiovisual data stream for retransmission in response to a user request.

23. The system of claim 21, further comprising a cable plant for carrying a transmission of said data stream from said head-end to a population of subscribing set-top boxes.

24. The system of claim 23, further comprising a set-top box for receiving said data stream and detecting said tags.

25. The system of claim 24, further comprising means for alerting a subscriber to tagged portions of said data stream.

26. The system of claim 25, further comprising a wireless remote control unit, wherein said subscriber is alerted to tagged portions of said data stream using said remote control unit.

27. The system of claim 26, wherein said remote control unit is a web-pad, said system further comprising a cable modem that communicates wirelessly with said web-pad.

28. A system for providing televised sporting events with enhanced user access to highlights from the sporting events, said system comprising:
a set-top box for receiving an audiovisual data stream of one or more sporting events, wherein said data stream includes tags identifying important events within the sporting events;
wherein said set-top box detects said tags.

29. The system of claim 28, further comprising a remote control unit in wireless communication with said set-top box, wherein said set-top box alerts a user to tagged portions of said data stream with said remote control unit.

30. The system of claim 28, further comprising an audiovisual recording device with said set-top box, wherein said set-top box records tagged portions of said data stream with said recording device.

31. The system of claim 30, wherein said recording device is a personal video recorder.

32. The system of claim 30, wherein said recording device is a video cassette recorder.

33. A system of providing enhanced coverage of televised sporting events, said system comprising:
means for producing an audiovisual data stream of a sporting event for transmission to subscribers; and
means for inserting tags in said data stream to create tagged portions of said data stream;
wherein said tagged portions of said data stream correspond to important events in said sporting event.

34. The system of claim 33, further comprising means for transmitting said data stream including said tagged portions.

35. The system of claim 34, further comprising:
means for receiving said data stream; and
means for alerting a user to said tagged portions of said data stream.

36. The system of claim 35, wherein said means for alerting a user comprise means for wireless transmitting information about tagged portions of said data stream to a user's remote control unit.

37. The system of claim 35, wherein said means for alerting a user comprise means for displaying information about said tagged portions of said data stream on a television set.

38. The system of claim 35, further comprising:
means for receiving user input regarding user interest in a tagged portion of said data stream; and
based on said user input, means for playing or ignoring said tagged portion of said data stream.

39. The system of claim 38, wherein said means for playing said tagged portion of said data stream further comprise:
means for transmitting said tagged portion to a remote control unit having a display device; and
means for playing said tagged portion of said data stream on said remote control unit.

40. The system of claim 38, wherein said means for playing said tagged portion of said data stream further comprise:
means for tuning to a virtual channel with a set-top box over which said tagged portion of said data stream is broadcast; and
means for playing said tagged portion of said data stream on a television set connected to said set-top box.

41. The system of claim 33, further comprising:
means for inserting in said tags a description of the important event marked by said tags; and
means for transmitting said data stream, including said tagged portions.

42. The system of claim 41, further comprising:
means for comparing said description with predetermined criteria; and
means for alerting a user to said tagged portions of said data stream if said description matches said predetermined criteria.

43. The system of claim 41, further comprising:
means for comparing said description with predetermined criteria; and
means for recording one or more tagged portions of said data stream if said description matches said predetermined criteria.

44. A system of providing enhanced coverage of televised sporting events, said system comprising:
means for receiving an audiovisual data stream of a sporting event; and
means for identifying electronically tagged portions of said data stream;
wherein said tagged portions of said data stream correspond to important events in said sporting event.

45. The system of claim 44, further comprising means for alerting a user to said tagged portions of said data stream.

46. The system of claim 45, wherein said means for alerting a user comprise means for wireless transmitting information about tagged portions of said data stream to a user's remote control unit.

47. The system of claim 45, wherein said means for alerting a user comprise means for displaying information about said tagged portions of said data stream on a television set.

48. The system of claim 45, further comprising:
means for receiving user input regarding user interest in a tagged portion of said data stream; and
based on said user input, means for playing or ignoring said tagged portion of said data stream.

49. The system of claim 48, wherein said means for playing said tagged portion of said data stream further comprise:
means for transmitting said tagged portion to a remote control unit having a display device; and
means for playing said tagged portion of said data stream on said remote control unit.

50. The system of claim 48, wherein said means for playing said tagged portion of said data stream further comprise:
means for tuning to a virtual channel with a set-top box over which said tagged portion of said data stream is broadcast; and
means for playing said tagged portion of said data stream on a television set connected to said set-top box.

51. The system of claim 44, further comprising:
means for comparing predetermined criteria with a description of the important event included with said tags identifying said important event; and
means for alerting a user to said tagged portion of said data stream if said description matches said predetermined criteria.

52. The system of claim 44, further comprising:
means for comparing predetermined criteria with a description of the important event included with said tags identifying said important event; and
means for recording one or more tagged portions of said data stream if said description matches said predetermined criteria.
